(19) United States
(12) Patent Application Publication
(10) Pub. No.: US 2017/0304711 A1
(43) Pub. Date: Oct. 26, 2017

(54) Blackjack Variations

(71) Applicant: Mario Santoro, Philadelphia, PA (US)

(72) Inventor: Mario Santoro, Philadelphia, PA (US)

(21) Appl. No.: 15/446,962

(22) Filed: Mar. 1, 2017

Related U.S. Application Data
(60) Provisional application No. 62/302,852, filed on Mar. 3, 2016.

(51) Int. Cl. A63F 1/00; G07F 17/32

(52) U.S. Cl. CPC A63F 1/00; G07F 17/3293; G07F 17/3209; A63F 2001/003; G07F 17/3246

(57) ABSTRACT

A variation of the casino game of blackjack which is played between players and without dealing a dealer's hand. Each player places an ante wager into a pot. Two cards are dealt to each player and the player with a hand closest to 21 without going over 21 wins the pot, minus any commission taken by the house. In another variation, a side wager can be offered on a standard game of blackjack (which uses a dealer's hand) which pays based on how many cards of a particular rank (e.g., ace) are present in a combined hand comprising both the player's and the dealer's hand.

### CROSS REFERENCE TO RELATED APPLICATIONS

This application claims benefit to U.S. provisional application 62/302,852, which is incorporated by reference herein in its entirety.

### BACKGROUND OF THE INVENTION

### Field of the Invention

The present general inventive concept is directed to a method, apparatus, and computer readable storage medium directed to a variation of the casino game of blackjack.

### Description of the Related Art:

The casino game of blackjack is well known, for example see U.S. patent publication 2003 0155715 which is incorporated by reference herein in its entirety.

FIG. 1 is a flowchart illustrating a method of implementing the known game of blackjack.

Points totals are computed by adding the standard rank value of each card, with face valued cards (tens, jacks, queens, kings) being given a value of 10, and aces being given a value of 1 or 11, whichever results in a better hand (an ace will not count as 11 if it would cause the point total to be over 21). A soft point total is where at least one ace is given the value of 11. A hard point total is a hand with all aces counting as 1.

In operation 100, the player makes a main wager by placing chips on a table. Then, in operation 102, the dealer deals two initial cards to each player (either face up or face down) and two initial cards to the dealer, typically one face down (“hole-card”), and one face up (the “up-card”). Then the player can decide whether to hit, stand, double, or split. If the player decides to hit, then the method proceeds to operation 106, which deals an additional card to a player. If a determination 108 determines that the player has busted (the player's hard point total is over 21), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by place an additional wager of up to the main wager, but the player is limited to drawing only one additional card before the player must stand.

If the player stands and has not busted out (either stands on his or her initial two cards or draws cards but has a point total under 22 and then stands), then the method proceeds to operation 112, which reveals all dealer's cards (e.g., turns the hole-card face up) and which then plays out the dealer's hand according to predetermined rules. In operation 114, if the dealer's total is greater than a predetermined amount (typically 17), then the dealer stands (proceeds to operation 122). If the dealer's total is not greater than the predetermined amount, the method proceeds to operation 116 which deals an additional card to the dealer. If it is then determined 118 that the dealer has not busted (has a point total over 21), the method returns to operation 114. If the dealer has busted, then the player wins the game and the main wager in operation 1020 (this assumes the player has not also busted; if the player has already busted then the player would have lost in operation 110).

In operation 122, both the player and the dealer have played out their hand and neither have busted. Thus, their respective point totals (adding the numerical values of each card in the hand) are compared. If the dealer's point total is determined in operation 124 to be lower than the player's point total, then the player wins the game and the main wager in operation 120 (paid at 1:1). Otherwise, if the dealer's point total is determined 128 to be greater than the player's point total, then the player loses the game and the main wager in operation 130. If the player's point total ties the dealer's point total, then that results in a “push” in operation 126 in which the player doesn't win or lose the main wager (the main wager bet is a wash).

If a player is initially dealt two identically ranked cards in operation 102, players can also split in operation 104 by placing an additional split wager equal in value to the main wager, and the player's two initial cards are separated and the dealer deals an additional card on each. The player then plays out each of the two separate hands, each from operation 104. Depending on house rules, players may or may not be allowed to re-split cards.

### SUMMARY OF THE INVENTION

It is an aspect of the present invention to provide an exciting casino game.

The above aspects can be obtained by a method that includes (a) providing at least one physical deck(s) of cards; (b) receiving an ante wager from each of a plurality of players into a pot; (c) dealing from the at least one physical deck(s) of cards a hand to each of the plurality of players; (d) enabling each of the plurality of players to play out their respective hand; (e) awarding some or all of the pot to a player out of the plurality of players who has a best blackjack hand.

The above aspects can also be obtained by an apparatus that includes (a) an electronic input device and an electronic output device; (b) at least one electronic processing unit connected to the electronic input device and the electronic output device, the electronic processing unit configured to read computer readable instructions from a non-transitory computer readable storage medium, the instructions programmed to cause the at least one electronic processing unit to (a) provide at least one virtual deck(s) of cards; (b) receive an ante wager from each of a plurality of players into a pot; (c) deal from the at least one virtual deck(s) of cards a hand to each of the plurality of players; (d) enable each of the plurality of players to play out their respective hand; (e) award some or all of the pot to a player out of the plurality of players who has a best blackjack hand.

The above aspects can also be obtained by a method that includes (a) providing at least one physical deck(s) of cards; (b) receiving a main wager from a player and a side wager (c) dealing from the at least one physical deck(s) of cards a hand to a player and a hand to a dealer; (d) enabling the player to play out the player's hand; (e) playing out the dealer's hand using blackjack rules; (f) resolving the main wager; (g) resolving the side wager based on a number of cards that are of a particular rank in both the player's hand and the dealer's hand.

The above aspects can also be obtained by an apparatus that includes (a) an electronic input device and an electronic output device; (b) at least one electronic processing unit connected to the electronic input device and the electronic output device, the electronic processing unit configured to read computer readable instructions from a non-transitory computer readable storage medium, the instructions programmed to cause the at least one electronic processing unit to (a) provide at least one virtual deck(s) of cards; (b) receive a main wager from a player and a side wager (c) deal from the at least one virtual deck(s) of cards a hand to a player and a hand to a dealer; (d) enable the player to play out the player's hand; (e) play out the dealer's hand using blackjack rules; (f) resolve the main wager; (g) resolve the side wager based on a number of cards that are of a particular rank in both the player's hand and the dealer's hand.

All features described herein can be added to the above example embodiments (whether played physically or electronically) without limitation.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing the known game of blackjack;

FIG. 2 is a flowchart illustrating an exemplary method of implementing a community blackjack game, according to an embodiment.

FIG. 3A is a drawing illustrating a gaming table, according to an embodiment;

FIG. 3B is a block diagram illustrating an electronic player tracking system associated with each gaming table, according to an embodiment;

FIG. 4A is a block diagram illustrating exemplary hardware that can be used to implement an electronic version of the methods described herein; FIG. 4B is a block diagram illustrating an exemplary network configuration to implement a player playing an online version of the methods described herein; and

FIG. 5 is a flowchart illustrating an exemplary method of implementing a side wager based on an ace count, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a player vs player community pot blackjack game. The goal is to win a community pot that is collected from the antes of all of the players for each hand dealt. Players compete against each other and not the house for every hand. Players can win by drawing blackjack or the highest hand closest to 21, without exceeding 21. In the event of a tie for the best hand, players have the option to play the tiebreaker round (or the rules can provide that the winning tieing players can equally divide the pot)

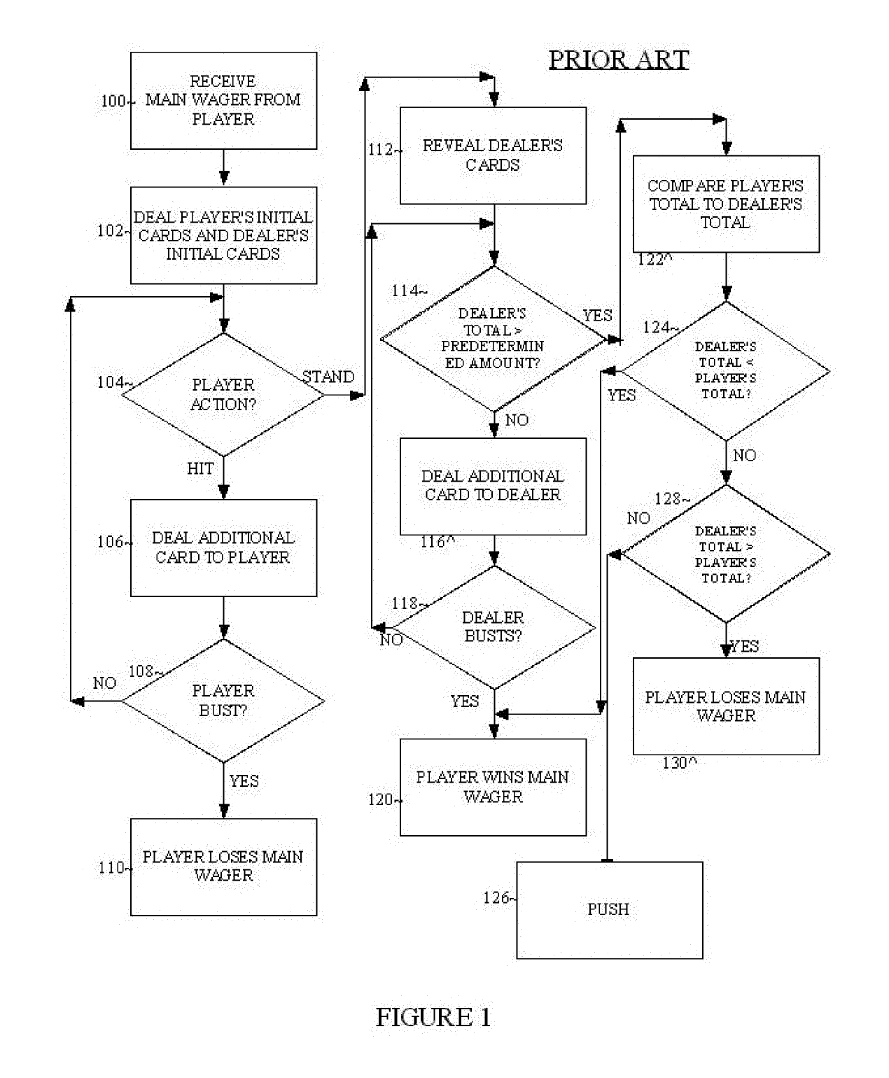

FIG. 1 is a flowchart illustrating a method of implementing the known game of blackjack.

In general, casino blackjack is played by one or more players at a gaming table against a dealer using one or more decks of cards (each deck can be a standard 52 card deck). The idea is for the player to make a point total closest to 21 without going over 21 (busting). Each player (after making a main wager) is dealt two initial cards (typically face up) and the dealer is also dealt two cards (one face up—the up—card, and one face down—the hole card). The player can stand on his or her initial two cards, or continuously hit (take another card) until the player stands or the player's point total is over 21(upon which the player automatically loses). If the player has not busted, then after the player stands the dealer will play out the dealer's hand according to predetermined rules. One set of dealer predetermined rules is as follows: the dealer will continuously hit until the dealer's point total is greater than 16. Once the dealer has resolved the dealer's hand, the wager is resolved. If the player has busted then the player loses (the main wager). If the player has not busted but the dealer has busted (the dealer's point total is over 21) then the player wins (wins even money on the main wager). If both the player and the dealer have not busted, then if the player's point total is higher than the dealer's point total then the player wins (wins even money on the main wager). If both the player and the dealer have no busted, then if the dealer's point total is higher than the player's point total then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as 1 or 11 (whichever makes the best hand), 2 's —10 's count as their respective face value, jacks, queens, and kings all count as 10).

In a variation of the standard game of blackjack illustrated in FIG. 1, there is no dealer's hand and instead the players all ante (put equal wagers into a pot) and all compete against each other (in the same manner as poker).

Table I below illustrates an exemplary set of rules for a community blackjack game.

TABLE I
a) Each player must bet the ante that becomes part of the pot to qualify for the hand.
Those bets become part of the community pot
b) Each player is dealt one card facing up and one card facing down, and is given an
opportunity to draw additional cards or stand pat. Only the first card is dealt face up but
the other cards can be dealt face down (although this is not required).
c) The player that draws blackjack or the hand closest to 21 without exceeding 21, wins
the community pot
d) In one embodiment, if a player achieves a “natural blackjack” (2-cards only), they are
required to reveal it, and if no other players tie, that player automatically wins the pot. A
natural blackjack automatically wins over any other combination of cards that equal 21.
e) When a tie occurs between two or more players, only these players are eligible to play
the tiebreaker feature (described herein)
f) In the event all players “bust” (exceed 21), only those same players qualify to play the
tiebreaker feature
g) Players are not required to inform the table when their hand is a bust. That player
continues to be eligible to play the tiebreaker bonus feature, should the rest of the players
at the table also bust.
h) When playing the hand, all other blackjack rules apply
i) Splitting Pairs- If a player wishes to split a pair he must pay the original cost of the ante
for each additional hand played. That bet becomes part of the community pot
j) Double Downs - do not apply, because it is a community pot
k) Pays: The winning hand collects the pot; that is comprised of the antes bet by the
players; i.e., 6 players = 6:1; 5 players = 5:1, etc.
l) House: House collects 10% of the pot, same as in some poker games
m) Tiebreaker Feature (optional). The Tiebreaker feature settles ties for the best hand
between two or more players. The cost to play the tiebreaker feature is equal to the
original ante, and must be bet prior to the cards being dealt. All bets are added to the
existing remaining pot. Only those players who have tied qualify to play the tiebreaker
feature, or forfeit their hand
n) In another embodiment, the cost to play the tiebreaker feature is equal to two times the
previous ante (original in the case of a first tie). Should subsequent ties occur, the cost is
twice the prior bet (e.g., if the ante is $10, the first tiebreaker cost $20, the next tiebreaker
cost $40, and so on until a winner has been declared).
o) When two or more players tie for a winning hand, only those players qualify to play
the tiebreaker
p) If those players playing the tiebreaker are dealt a hand that leads to another tie, the pot
remains and the bet feature must be played again until a winner has been reached.
q) The player that wins the tiebreaker wins the pot
r) The House collects 10% of the pot

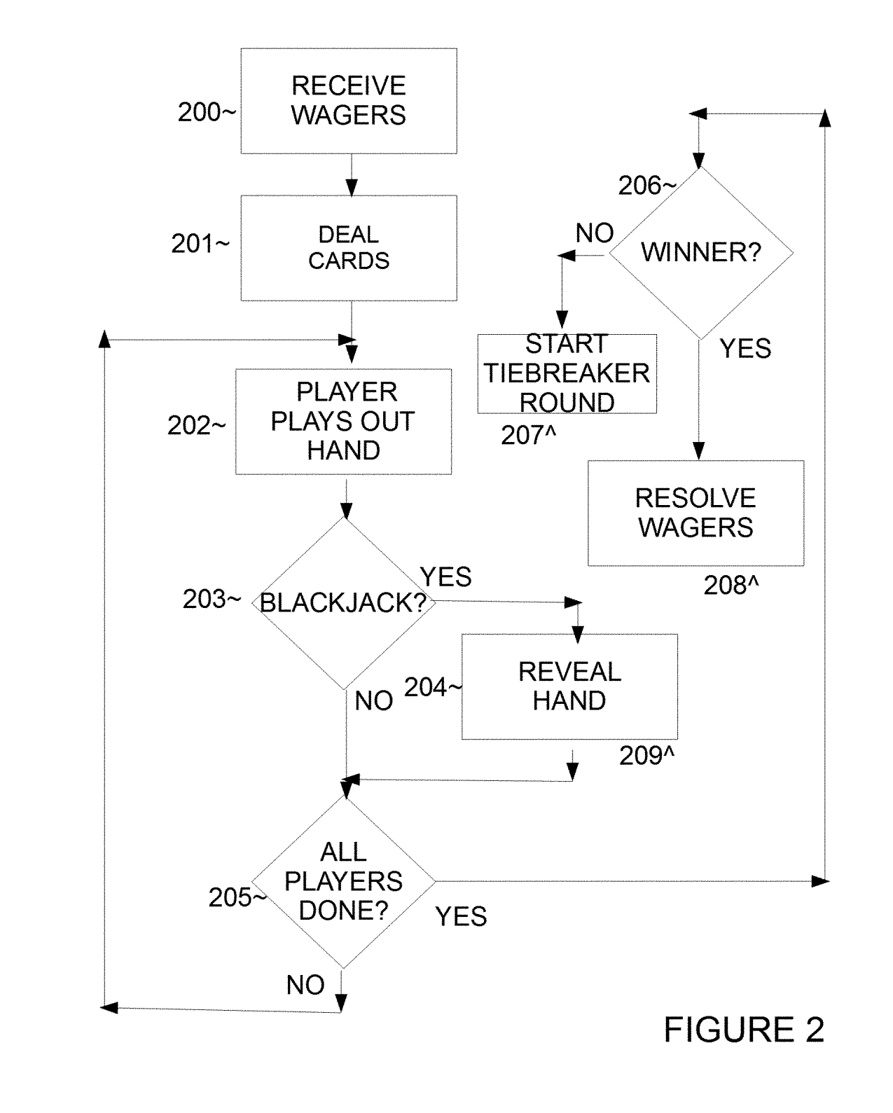

FIG. 2 is a flowchart illustrating an exemplary method of implementing a community blackjack game, according to an embodiment. The community blackjack game is a player versus player game, wherein players are playing against each other but there is no dealer hand (i.e., the dealer gets zero cards).

The method can begin with operation 200, which receives wager(s) from the player(s). Each player puts an ante wager into a pot, each ante wager being an equal amount. Players can also make optional side wagers as well. The pot can be in the center of the table, or the players can put wagers into the pot by putting their wager in a betting circle near their position on the table (all such bets would be considered the “pot”).

From operation 200, the method proceeds to operation 201, which deals two cards to each player face down (in another embodiment one card can be dealt face down while one card can be dealt face up). Each player will then perform operations 202 to 204 in turn until all players have acted.

In operation 202, the player plays out his/her hand by hitting, standing or splitting (although in one embodiment splitting is not allowed). The cards are all dealt face down, so the other players can see how the other players are playing their hands (hit, stand, split, etc.) but not what the cards are. If the player busts the other players will not be informed of this fact.

From operation 202, the method proceeds to operation 203, which determines whether the player has a blackjack (two card 21). If the player has a blackjack then the method proceeds to operation 204 in which the player then must reveal his hand (turn his/her blackjack face up).

If in operation 203 the player does not have blackjack, then the method proceeds to operation 205, which determines whether the players are all done playing out their hand. If there are more players that still have to play out their hand, then the method returns to operation 202 wherein the next player will then play out his/her hand at operation 202. Play can proceed from one player to the next in a particular direction (e.g., clockwise or counterclockwise).

Once all of the players have played out their hands in operation 205, then the method proceeds to operation 206, which determines who is the winner. The winner is the player with the best blackjack hand (closest to 21 without going over). A blackjack (two card 21) beats any other 21(three cards or more).

If there is a single winner (no tie) in operation 206, then the method proceeds to operation 208, which resolves all of the wagers by awarding the pot to the winning player. The pot is all of the ante (main) wagers placed by all players in operation 200. This is typically in the form of chips and the winning player collects all of the physical chips for himself/herself. In the electronic version of the game, then the chips are “virtual” in that they exist as electronic credits which are then all electronically transferred to the winner (while the ante wagers were all electronic debited from each player's credit total when the wagers were first placed in operation 200). Note that in an embodiment the winning player receives the pot minus any house commission (discussed herein) in the embodiment where the house gets commission on each game. In operation 208 all side wagers are resolved as well (taken or paid).

If there is no single winner in operation 206 (in other words there is a tie among the best ranking hands), then the method proceeds to operation 207. In operation 207, a tiebreaker round is initiated in which the same method (as described herein) is performed again with only the tieing players but this time they must ante double the previous ante amount. Then the tieing players only (but not the losing players) will then play another round (operations 201 to 208 after each player who qualifies for the tiebreaker round (by tying for the win) has placed their ante wager for the tiebreaker round). If there is still a tie for the highest hand again, then the winning players will then put in double the previous ante and continue playing such rounds until there is a single winner. For example, if the ante on the original game is $1, then on the tie breaker round the ante would be $2, then $4, then $8, and so on. All of the antes go into the same pot and the player who finally wins (no ties for the winner) wins the entire pot. The tieing players are the players who tie with the best hand, for example if there are five players and each player has a hand of (bust, 12, 17, 17, bust) then since the ‘17’ is the best hand and there is more than one player with a total of 17 then the two players with the total of ‘17’ are the players who proceed to the tiebreaker round. Note that ‘bust’ is the worst possible hand (although if all players at the table bust then all players at the table would proceed to the tiebreaker round).

When a player wins the pot, the house (e.g., casino, web site offering an electronic version, company operating a server which operates an electronic version) may take a commission out of the pot (e.g., 5%, 10%, or other number.) in the same manner that a poker room takes a “rake” in order for the house (casino) to make a profit on the game. The commission can be taken at the end of the game when there is a winner of the pot, or alternatively as each player places a wager into the pot. For example, if there are 6 players, and each player has placed a $5 ante, then there is $ 30 in the pot and at the end of the game (after a single winner is determined) then 10% of the pot is $3 and so the house (casino, or operator of an online web site/server that offers the game) gets $3 and the winning player gets $27.

In one embodiment, a player at a particular position at the table will go first and when a player is finished playing out his/her hand play will continue to a next player in a particular direction (e.g., clockwise or counterclockwise) at the table. In another embodiment, the player that goes first (plays out his/her hand in operation 202 is chosen randomly (e.g., using dice or an electronic random number generator). In another embodiment, the player who goes first rotates after each game, in the same manner that this is done in poker. For example, if there are six player spots at the table, the player in spot #1 goes first, then player continues to the player in spot #2, then the player in spot #3, etc. Then in the next game, the player in spot #2 goes first, and then the play continues to the player in spot #3, then #4, then #5, then #6, then #1. In this manner, the first player rotates around the table until all players have had a chance to go first, and then the player in spot #1 can again be the first player to play out his/her hand. A “button” (a large visible disc) can be used to designate which player is going first and this button can be passed around the table after each game is completed.

A side wager can be offered called community blackjack which is placed at the beginning of the game (operation 200) for use with the game illustrated in FIG. 2. The goal to win the bet is to get a blackjack. Out of all of the players who play the community blackjack side wager, if none get a blackjack then all of the side wagers are pushed (neither win nor lose). Out of all of the players who play the community blackjack side wager, if one gets a blackjack then that one player who gets the blackjack will win all of the other community blackjack side wagers that were placed. If more than one player who players the community blackjack bet gets blackjack, then this can be handled in numerous ways. In one embodiment, all of the players who get blackjack who made the community blackjack side wager will share equally the winnings (all of the community blackjack side wager).

The community blackjack side wager is placed as follows. Players place a bet equal to the ante (in another embodiment it does not have to be equal to the ante), on the designated location on the board. This bet is made simultaneously with the ante bet, prior to the dealing of the hand. If no participating player in the community blackjack bet is dealt blackjack (Blackjack=21 with two cards only), then the blackjack bonus is returned to the players who make the community blackjack bet (“bet” is synonymous with “wager” herein). If a participating player is not playing the community blackjack bet, and draws blackjack, they are not entitled to any proceeds from this bonus feature. The player that bet the blackjack bonus feature collects the bets from all of the other blackjack bonus participants only. If only one participating player plays the community blackjack feature, the House (casino) can pay the player 2:1. The house collects 10% (or other percentage) of the community blackjack side wager pot (all community blackjack side wagers). In the event of a tie (more than one player who plays the community blackjack side wager) gets blackjack, then this can be handled in numerous ways: 1) each player who gets blackjack (and made the community blackjack bet) divides the pot (all community blackjack bets for that round) equally; or 2) tiebreaker rules can apply (e.g., additional hands can be dealt only to each player who has blackjack until one player has a winning hand such as blackjack).

Another side wager can be offered called perfect blackjack which is placed at the beginning of the game (operation 200) for use with the game illustrated in FIG. 2. This side wager wins when the player is dealt a blackjack or draws to a 21. Otherwise, this side wager loses. Table II below is a sample payout table for this bet. Of course it can be appreciated that this is merely one possible paytable, and other paytables can be devised as well. For example, another paytable can be: perfect blackjack (only a jack and ace of spades) pays 200:1/three 7's pays 100:1/suited blackjack pays 25:1/five card 21 pays 20:1/any blackjack pays 2:1/and all other combinations lose.

TABLE II

| | # | P | Odds | | |
|---|---|---|---|---|---|
| Event | (Event) | (Event) | (1-in) | Payout | Value |
| Ace-Jack | 740582 | 0.000741 | 1,343.7 | 200 | 0.148116 |
| of spades | | | | | |
| Ace-face | 11120542 | 0.011121 | 89.5 | 40 | 0.444822 |
| suited | | | | | |
| 7-7-7 | 403646 | 0.000404 | 3,250.5 | 7 | 0.002826 |
| Five-card | 14677387 | 0.014677 | 69.9 | 5 | 0.073387 |
| 21 | | | | | |
| Other | 35572630 | 0.035573 | 28.0 | 2 | 0.071145 |
| blackjack | | | | | |
| All others | 937485213 | 0.937485 | 1.1 | −1 | −0.937485 |
| Totals: | 1,000,000,000 | 1.000000 | | Return: | −0.197189 |

In another embodiment, the community blackjack game illustrated in FIG. 2 (and any of the side wagers which can be optional) can be offered in a tournament format. A tournament format is where non-cash value chips are used instead of cash value chips. Cash value chips can be exchanged for real cash, while non-cash value chips (also referred to as virtual currency) does not have any cash value and hence cannot be redeemed (exchanged) for cash. Tournament players can each be given a fixed amount of non-cash value chips (e.g., $100) and can play until the tournament ends. The tournament would implement the community blackjack game illustrated in FIG. 2 (and any of the wagers which are optional) with the players betting their non-cash value chips (instead of betting real cash value chips (exchangeable for real cash) which is done in the play for real money embodiment). The tournament would end based upon predetermined rules (e.g., after a predetermined amount of time, or one player has obtained all of the chips from all of the other players, etc.) Winning players would be paid in non-cash value chips. The player with the most non-cash value chips after the tournament is over would win the tournament and could win a prize (e.g., a cash prize, a non-monetary prize such as a car, etc.) In an embodiment, more than one player can be a winner (e.g., the three players with the most non-non-cash value chips at the end of the tournament win a first, second, and third prize).

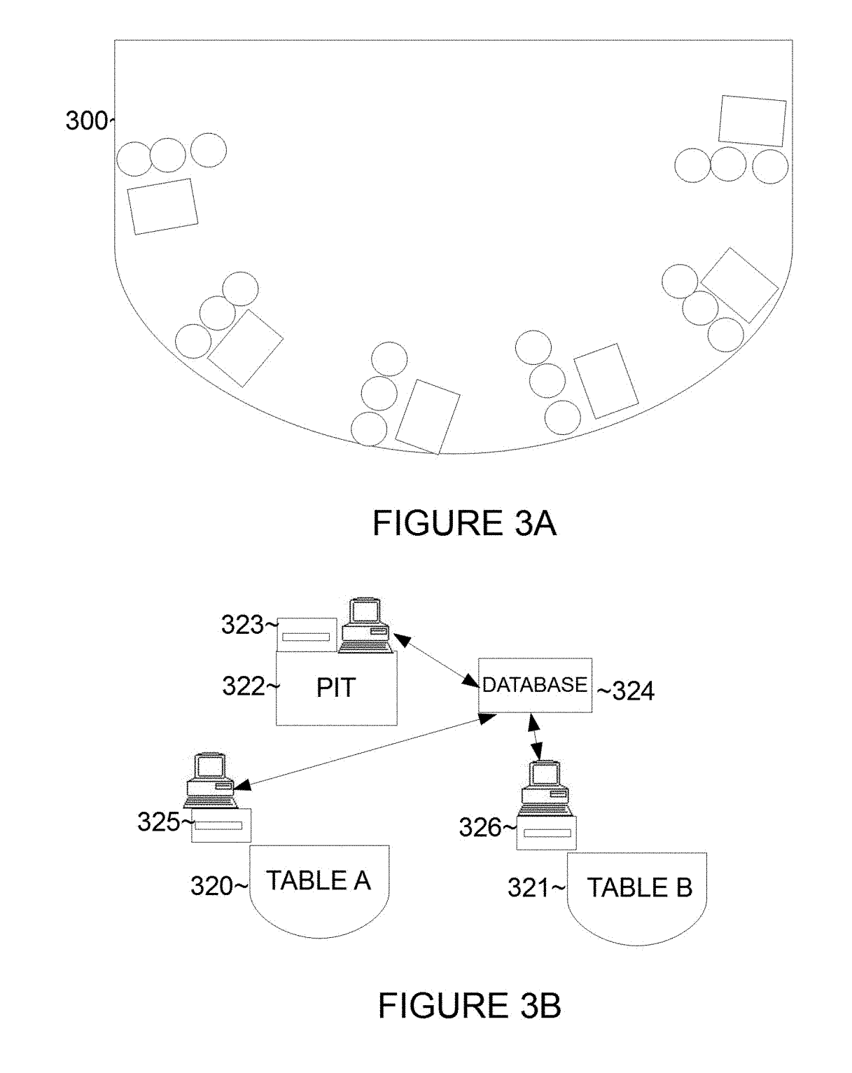

FIG. 3A is a drawing illustrating a gaming table, according to an embodiment.

A physical gaming table 300 (typically made of wood with felt on top with the layout imprinted on it) is used to play the game in a physical real world casino. One example of a table that can be used in a physical casino is illustrated in U.S. Design Pat. D 263,975 which is incorporated by reference herein in its entirety. The layout on top of the felt has imprinted on it six betting areas as illustrated in FIG. 3A, each betting area comprises three betting circles which is where the respective player can place their chips (wagers). The three betting circles are for the main (ante) wager (which can be considered the “pot”, the community blackjack optional side wager and the perfect blackjack side wager (side wagers are also referred to as side bets). The felt can be green and the imprinted betting circles can be white, although of course any color scheme can be used. Such a table can accommodate any number of players (such as seven as illustrated) or any other number (e.g. 2-10). Placing any of the side wagers can be optional on the decision of the player.

While not shown, the game can also be offered with any type of additional side wager in order to generate more action for the casino and more excitement for the players. Also not pictured in FIG. 3A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 3A is an optional shoe which the cards can be placed into and dealt out of by the dealer, such as the shoe described in U.S. Pat. No. 4,457,512 which is incorporated by reference herein in its entirety.

FIG. 3B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

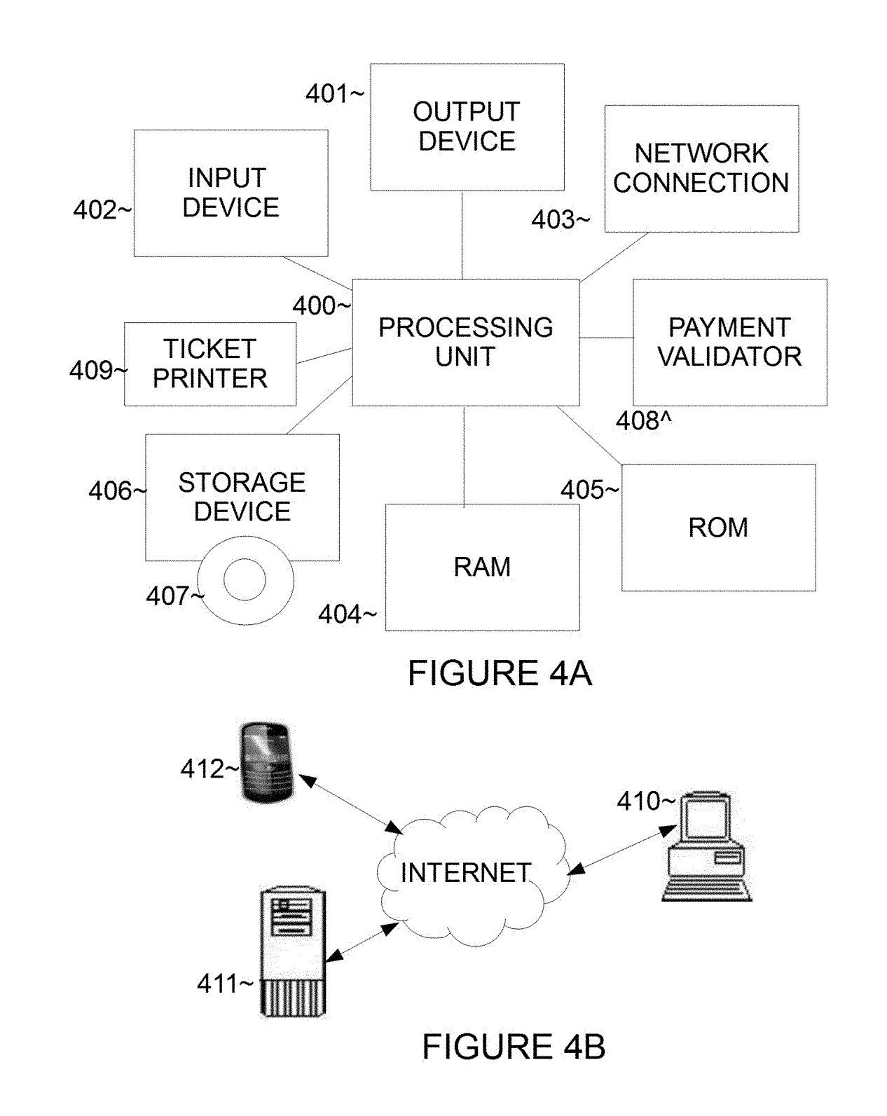

A gaming table A 320 (which can be used to play any method described herein) and a gaming table B 321 (which can be used to play any method described herein) can be associated with a pit 322 (which has its own computer) which has a card reader 323 to read the electronically encoded information on a player's card (the card reader can also be located at the tables themselves) and transmit the information to an associated computer which can communicate information contained on the player's card (e.g., an identification number of the player associated with the card) to the electronic database 324 along with play data relating to the player who owns the player's card. Table A 320 has its own card reader 325 and associated computer (the one next to card reader 325 which receives information from the card reader 325) and table B 321 also has its own card reader 326 and associated computer (the one next to card reader 326 which receives information from the card reader 326). The computers at table A 320 and table B 321 are connected to the electronic database 324. Casino employees can enter data regarding each player's play (for those players that present a players card) into a computer at the table or at the pit which transmits the play data (e.g., average bet amount, time of play, etc.) to the electronic casino database 524 that stores playing history information for players at the casino. The computers illustrated in FIG. 3B can all have the structure as illustrated in FIG. 4A.

FIG. 4A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The digital casino table has a plurality of individual output devices, individual input devices, and individual payment mechanisms (e.g., bill acceptor) so a plurality of players (each player having their own respective input device, output device, and payment mechanism) can play against each other at the same table (the table may also have a common output device in the middle of the table in view of all of the players at the table), so players can play out their own hand on their own output/input device (the output device hidden from the other players) but the common output device displays information such as who has the winning hand and what the winning is, etc. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety. The game can also be played on a video slot machine (the kind that is found in physical casinos).

A processing unit 400 (such as a microprocessor and any associated components such as power supply, etc.) is connected to an output device 401 (such as an LCD monitor, a touch screen, CRT, etc.) which is used to display to the player any aspect of the method, and an input device 402 (e.g., buttons, the touch screen, a keyboard, mouse, etc.) which can be used to input from the player any decision made by the player (e.g., how much to wager, what action to take (e.g., hit, stand, etc.)) All states of the game (e.g., cards dealt, wagers made can be displayed on the output device 401. All methods and features described herein can be performed by the processing unit 400 by loading and executing respective instructions. Multiple such processing units can also work in collaboration with each other (in a same or different physical location). The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a disk drive, DVD-drive, CD-ROM drive, flash memory, etc. A non-transitory computer readable storage medium 407 (e.g., hard disk, CD-ROM, etc.), can store a program which can control the electronic device to perform any of the methods described herein and can be read by the storage device 406.

The processing unit 400 can also be connected to a payment validator 408. The payment validator 408 can be a bill acceptor which accepts currency, identifies it as being valid (typically by using an optical scanner), and then credits the inserted bill amount to the machine (for example inserting a $10 bill will credit the machine with $10 in credits (credits can also be considered chips that the player can wager with in the game). The bill acceptor can also accept cashless tickets as part of a ‘ticket-in-ticket-out” system, in which tickets (cashless vouchers) have cash value and can be inserted into the payment validator 408. The validator 408 validates the ticket (typically be optically scanning a bar-code), communicating electronically with a casino database to verify the ticket is authentic, and once authenticated then crediting the machine with the respective amount of credits. The payment validator 408 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for playing the machine. If such a card is used, then the player can optionally enter (using a keypad) an amount the player wishes to withdraw from the account associated with the card to credit to the machine.

The processing unit 400 can also be connected to a ticket printer 409 which can print tickets (cashless vouchers). When the player cashes out on the machine (indicated to the machine that the player wishes to cash out and terminate by, typically by pressing a button), a ticket is printed by the ticket printer 409 which carries the amount of credits left on the machine. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

The processing unit 400 can also be connected to an electronic card reader (not pictured in FIG. 4A). A player's card is a card with an electronically encoded unique identifier (e.g., magnetic stripe) that the player would insert into the card reader. The card reader then reads the electronic encoding on the card and communicates the player's play vto the casino database. In this way, the casino database can track this player's play so that the casino can provide this player incentives. For example, every bet (“bet” and “wager” are used synonymously herein) can be communicated to the casino database and stored (associated with this particular player's account as identified on the player's inserted player's card). A player's card reader is described in U.S. Pat. No. 5,655,961 which is incorporated by reference herein in its entirety. A “player's card” is also known in the industry as a “comp card” or “loyalty card.”

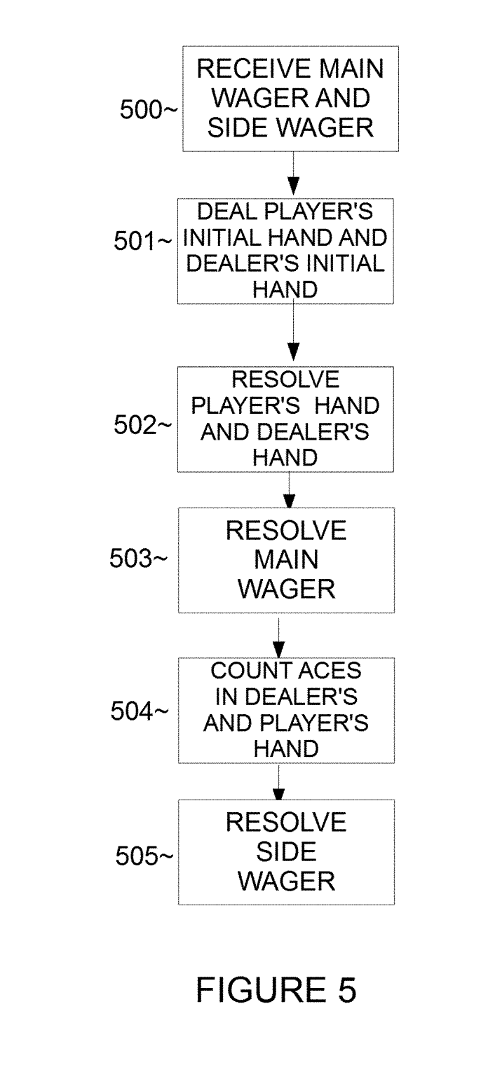

FIG. 4B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 410 (e.g., cell phone, tablet, PC, etc.) can connect to a server 411 (which can have the structure illustrated in FIG. 5A) using a computer communications network such as the Internet. The server 411 hosts an online casino which determines the outcomes of the game and serves the outcomes to the computer 410 so the computer 410 displays the outcomes to the player. Other users can also play at the online casino hosted by the server 411 simultaneously, such as using a cell phone 412 with wireless internet connectivity. Any number of players connected to the internet can play contemporaneously at the sever 411. The general structure of online casinos is well known in the art.

In a further embodiment, the present inventive concept relates to a method, apparatus, and computer readable storage medium to implement a blackjack ace side wager. The main wager is resolved as a standard game of blackjack. To resolve the ace side wager, all of the aces are counted between the dealer's hand and the player's hand. If multiple players are playing, the player's aces are only used for each individual player's hand but players’ hands are not combined. After the player's aces and the dealer's aces are totaled, the ace total is compared to a paytable. The paytable pays an award if the player as a minimum number of aces otherwise the ace side wager loses. If the player splits his/her hand, all of the aces in both split hands will be considered in the player's hand (and used for the total number of aces). In another embodiment, only the aces in one of the split hands will be used.

FIG. 5 is a flowchart illustrating an exemplary method of implementing a side wager based on an ace count, according to an embodiment. In the embodiment illustrated in FIG. 5 (unlike the embodiment illustrated in FIG. 2), this is more like a standard game of blackjack in which the dealer is dealt a hand (as illustrated in FIG. 1).

The method starts with operation 500, which receives from the player a main wager and an ace side wager. This can be done as described in operation in operation 100. Note that the ace side wager can be optional, that is, the player is free to make the ace side wager or omit the ace side wager as long as the player makes the main wager.

Typically there is a betting maximum on both the main wager and the ace side wager (e.g., $1,000 or other amount).

From operation 500, the method proceeds to operation 501, which deals the player's initial hand (two cards) and the dealer's initial hand (two cards). This can be done as in the standard game of blackjack (operation 102).

From operation 501, the method proceeds to operation 502, which resolves the player's hand and the dealer's hand. This can be done as in the standard game of blackjack (operations 104-118).

From operation 502, the method proceeds to operation 503, which resolves the main wager. This can be done as in the standard game of blackjack (operations 120-130).

Another way to look at the present inventive concept is the prior art game of blackjack as illustrated in FIG. 1 is completed but with the addition that an ace side wager is received from the player in operation 100 and this ace side wager is resolved (as described herein) after (or before) the main wager is resolved. The ace side wager should be resolved after all cards (both player and dealer) have been dealt.

From operation 503, the method proceeds to operation 504 which counts all of the aces in the dealer's hand and the player's hand. This includes the dealer's initial two cards (dealt in operation 501/102), all of the dealer draw cards (dealt in operation 116), the player's initial two cards (dealt in operation 501/102) and all of the player's draw cards (dealt in operation 106).

From operation 504, the method proceeds to operation 505, which resolves the ace side wager. This is done based on the total ace count (from operation 504). It does not matter whose hand (the player's or the dealer's) hand each ace was present in. A paytable such as that illustrated in Table III below can be used to resolve the ace side wager by comparing all of the aces present in both the player's and dealer's hand with the paytable.

TABLE III

| Hand | Payout |
|---|---|
| Two unsuited aces | 4:1 |
| Two suited aces | 10:1 |
| Three unsuited aces | 30:1 |
| Four unsuited aces | 100:1 |
| Three suited aces | 200:1 |
| Four aces (one of each suit) | 300:1 |
| Four suited aces | 400:1 |
| Five or more aces | 500:1 |
| All others | −1 (lose) |

In Table III, suited means that the aces are all of the same suit. Unsuited means that the aces are of any suit (but not of the same suit). The four aces (one of each suit) means that each of the four aces is a different suit (one ace of each of the four suits). If the aces in both the player's hand and the dealer's hand meet the criteria for any of the entries in the paytable then the player wins the respective payout (e.g., if the player bet $1 on the ace side wager and the payout is 400:1 then the player is paid out $400 in profit). If the player's hand does not meet any of the criteria then the player loses the ace side wager (no payout). If the player qualifies for multiple payouts on the paytable the player is only paid the highest payout. For example, if the player's hand is ace-hearts 7 (total 18) and the dealer's hand is ace-hearts/9 (total 20) then the player (if he/she bet $1 on the ace side wager) would be paid 10:1 (i.e. an additional $10) because after combining both hands (the player's hand and the dealer's hand) there are two suited aces. If the player and/or dealer drew cards in their hand (after being dealt the initial two cards) the draw cards would also count towards the ace total.

Note that in addition to aces, other ranks can be used instead of aces to implement the ace side wager. For example, instead of aces, the ace side wager can be a “king side wager” and kings can be counted and paid instead of aces. In other words, the ace side wager can be played using the same rules but substituting any other rank instead of aces. This, in Table III, instead of “ace” substitute any other rank (e.g., 2-10, jack, queen, or king). Thus, in a “kings” embodiment, according to table III, five or more kings would pay 500:1 (instead of 5 or more aces). For the ace side wager embodiment, in FIG. 3A, on the gaming table there can be two betting circles (one for the main wager and one for the ace side wager) instead of three.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card. A virtual deck is comprised of virtual cards (e.g., 52 virtual cards).

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

The word “deal” as used herein can mean two things: a) physically deal a card from a deck (real or virtual) face up or face down; b) reveal (turn face up a face down card) which was previously dealt. Thus, “dealing” includes taking a card from the shoe (if one is being used) and putting it on the table (face up or face down), or taking a card from the shoe (if one is being used) and putting it face down on the table and then (at a later point in time) turning it face up. Thus, if a three card hand is dealt two cards face up and one card face down (which is turned face up later), or a three card hand is dealt two cards face up and at a later time the third card is dealt face up, these are equivalent and both fall under the word “deal.”

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a blackjack game, the method comprising:
providing at least one physical deck(s) of cards;
receiving an ante wager from each of a plurality of players into a pot;
dealing a hand to each of the plurality of players;
enabling each of the plurality of players to play out their respective hand;
awarding some or all of the pot to a player out of the plurality of players who has a best blackjack hand.

2. The method as recited in claim 1, wherein the best blackjack hand is a hand which is closest to a point total of 21 without going over 21.

3. The method as recited in claim 1, wherein a house collects a percentage of the pot.

4. The method as recited in claim 1, wherein the player who has the best blackjack hand is awarded the port minus the percentage of the pot collected by the house.

5. The method as recited in claim 1, wherein the ante wagers are non-cash value chips and the game is played as a tournament.

6. The method as recited in claim 1, wherein the ante wagers are cash-value chips.

7. The method as recited in claim 1, wherein if only one player out of the plurality of players is initially dealt a blackjack then that one player wins.

8. The method as recited in claim 1, further comprising receiving a side wager at a same time as the ante wager and providing side wager rules that the side wager wins a pfayout when a point total of a player's hand equals 21 and loses when the point total of the player's hand is not 21.

9. The method as recited in claim 8, wherein the side wager rules provide that a suited blackjack pays higher than a five card 21.

10. The method as recited in claim 1, wherein players cannot double d own.
